(19) United States
(12) Patent Application Publication
(10) Pub. No.: US 2020/0396959 A1
(43) Pub. Date: Dec. 24, 2020

(54) AUTOMATIC LIVING FOOD DISPENSER

(71) Applicant: Verge Exotic Pet Products, LLC, Columbia, IL (US)

(72) Inventor: Nicholas David Bahr, Columbia, IL (US)

(73) Assignee: Verge Exotic Pet Products, LLC, Columbia, IL (US)

(21) Appl. No.: 16/520,475

(22) Filed: Jul. 24, 2019

Related U.S. Application Data
(60) Provisional application No. 62/864,074, filed on Jun. 20, 2019.

(51) Int. Cl. A01K 5/02

(52) U.S. Cl. CPC A01K 5/0275; A01K 2227/706; A01K 2227/50; A01K 5/0291

(57) ABSTRACT

An automatic living food dispenser is provided as a top lid with air circulation holes, a rotatable carousel with cavities and nutrient compartments for storing and maintaining living food, a main compartment housing the carousel with a food release hole, a base unit for supporting the main compartment, a rotary mechanism to rotate the carousel relative to the base unit, and a control unit to control the function of a timer that indicates food release times. The control unit is configured to deliver signals to the motor to actuate a dispensing mechanism in response to settings preset by a user. At food release times, the rotary mechanism rotates the carousel and consequently pushes stored living food in the main compartment in a circular manner such that the living food may gravitationally drop through the food release hole to an external environment for the caged pet to consume.

### CROSS-REFERENCE TO RELATED APPLICATIONS

The present invention claims priority to U.S. Provisional Application Ser. No. 62/864,074 filed Jun. 20, 2019.

### BACKGROUND OF THE INVENTION

The present invention generally relates to a system and method for automatically dispensing living food to caged pets. More specifically, the present invention may be used to provide a convenient apparatus for habitation and dispensing of crickets to cricket-eating reptile.

By way of introduction, reptiles of all sizes are kept as pets. Common species of pet reptiles include turtles, frogs, snakes, and a wide array of lizards, such as bearded dragons, crested geckos, leopard geckos, iguanas, and chameleons. Ordinarily, the reptiles live their daily lives in an open or closed aquarium or terrarium, preferring a controlled habitat with water, food, and a heat source. Living food, most commonly crickets, is an integral part of the diet of most reptile species that are commonly kept as pets.

Live insect containers as well as conveying device have been developed. One example is U.S. Pat. No. 6,758,162 entitled “Reptile Feeder.” The '162 patent describes a method of feeding insects by providing a feeding apparatus consisting of a structure having a chamber in which the insects can move about, a cover that provides access to the chamber for introducing insects and powder supplements to the chamber, and a small port and manually removable port plug for enabling the insects to exit the chamber to the terrarium when the plug is removed.

An improved insect storage and dispensing device was disclosed in U.S. Pat. No. 6,877,269 entitled “Insect Container.” The '269 patent discloses an insect container that provides for holding, transporting, and singularly extracting individual crickets. The insect container includes hollow carrying tubes where insects reside until manually removed from the device to feed reptiles kept in separate terrarium.

U.S. Pat. No. 7,174,847 is entitled “Insect Habitat and Feeder.” This patent teaches an insect habitat and feeder, comprising of a tower compartment connected to a separate dusting compartment with apertures on both compartments that may be aligned by rotating the two compartments to form a passage for insects. The insects can move from the tower compartment to the dusting compartment which coats the insects with a nutritional dust. The insects are then allowed to move from dusting compartment through a feeder tube into a pet animal's habitat for consumption.

### BRIEF SUMMARY OF THE INVENTION

One or more of the embodiments of the present invention provide a system and a method for automatically dispensing living food to a caged pet. More specifically, the present invention may be used to provide a convenient apparatus for habitation and dispensing of living food, such as crickets, to a caged pet, such as cricket-eating reptiles. The system includes a top lid with air holes for air circulation, a rotatable carousel with cavities and nutrient compartments for storage and sustenance of living food, a main compartment casing the rotatable carousel having a food release hole, a base unit for seating the main compartment, a rotary mechanism to turn the rotatable carousel relative to the base unit, and a control unit to control the function of a timer that transmits signals indicating food release times. At food release times, the control unit is configured to deliver signals indicating execution to release living food to the motor to actuate a dispensing mechanism in response to timer settings preset by a user. Upon receiving a signal indicative of execution to release living food, the rotary mechanism rotates the rotatable carousel and consequently displaces stored living food in the main compartment circularly such that the living food may gravitationally drop through the food release hole to an external environment for the caged pet to consume. Alternative embodiments include additional features, such as a control panel comprising of a user interface for setting the timer according to a desired feeding schedule, a communication unit or connection to a communications network for remote control, a solar panel cells for additional power supply, and a video recording system for tracking pet activities.

### BRIEF DESCRIPTION OF THE DRAWINGS

FIG. 1 illustrates an exploded perspective view of one embodiment of an automatic living food dispenser, showing individual components.

FIG. 2 illustrates an assembled view of an open automatic living food dispenser.

FIG. 3 illustrates an assembled view of a closed automatic living food dispenser.

FIG. 4 illustrates a bottom view of an automatic living food dispenser.

FIG. 5 illustrates a detailed inner view of a base unit.

FIG. 6 illustrates a detailed view of a base unit with a base lid and a drive wheel.

FIG. 7 illustrates a detailed bottom view of a main compartment.

FIG. 8 illustrates a detailed top view of a main compartment.

FIG. 9 illustrates a detailed assembled view of the main compartment and the base unit.

FIG. 10 illustrates a detailed view of a rotatable carousel.

FIG. 11A illustrates a detailed bottom view of a rotatable carousel.

FIG. 11B illustrates another rotatable carousel configured to be easily removed and swapped out to provide another type of feeding compartment for holding different insets.

FIG. 12 illustrates a detailed bottom view of a top lid.

FIG. 13 illustrates a detailed top view of a top lid.

FIG. 14 illustrates one embodiment of an automatic living food dispenser with optional features.

FIG. 15 is a flowchart illustrating an embodiment of a process for initiating the motor executed by the automatic living food dispenser.

FIG. 16 illustrates an automatic living food dispenser according to an embodiment of the invention.

### DETAILED DESCRIPTION OF THE INVENTION

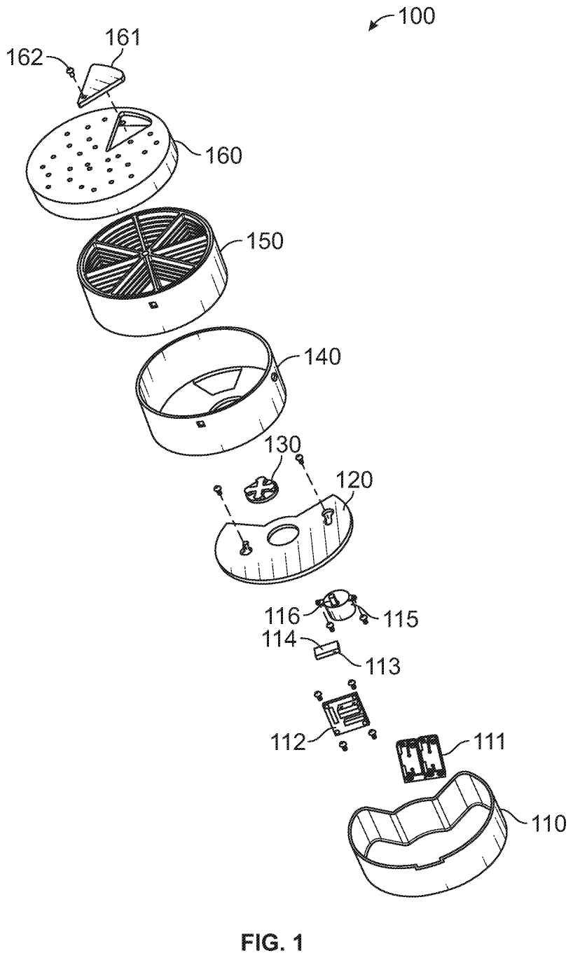

FIG. 1 illustrates an exploded perspective view of an automatic living food dispenser system 100 including a base unit 110, a base lid 120, a drive wheel 130, a main compartment 140, a rotatable carousel 150, and a top lid 160. The base unit 110 includes a battery compartment 111, a control unit 112, a switch 113, a switch base 114, a motor 115, and a drive shaft 116. The top lid 160 includes a loading cover 161 and a top screw 162.

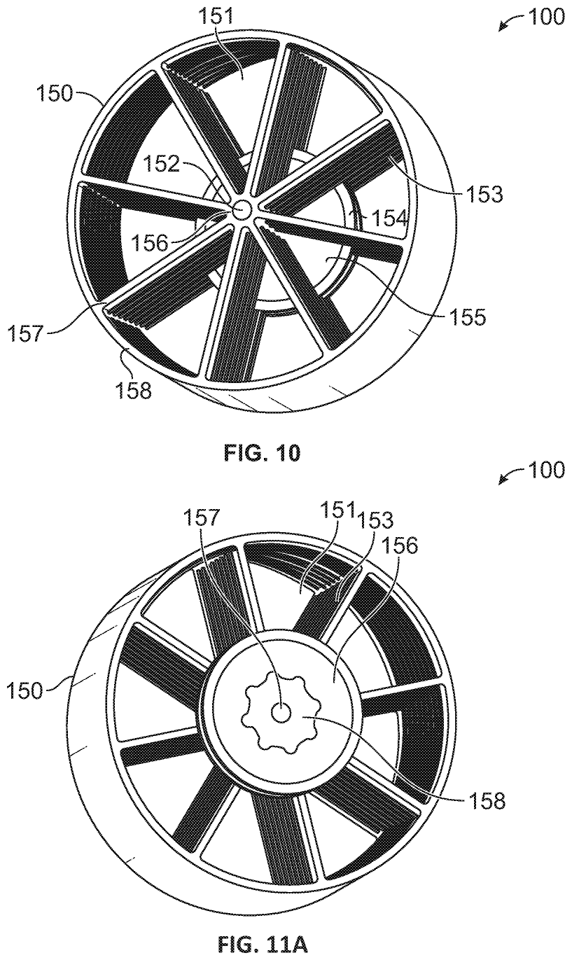

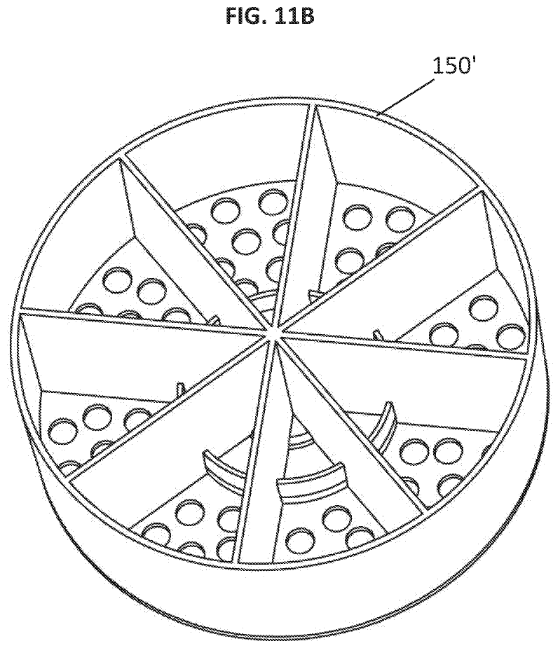

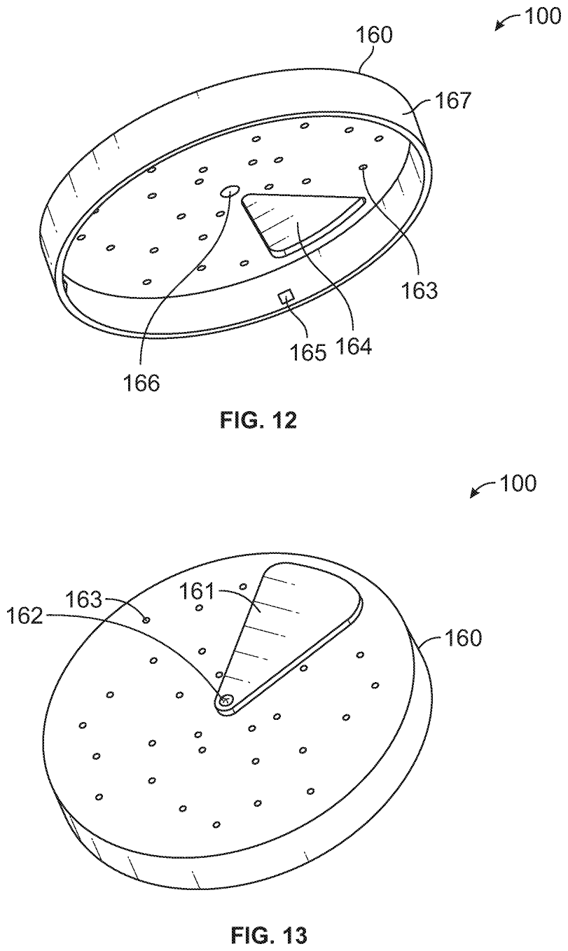

The base unit 110 holds controls and mechanisms that allow for rotation of the rotatable carousel 150 and for performance of other functions of the automatic living food dispenser 100. The base unit 110 houses the battery compartment 111, the control unit 112, and the motor 115. The control unit 112 is electrically connected to the battery compartment 111 and the motor 115. The drive shaft 116 is mechanically attached to the motor 115. The base lid 120 is fitted over the base unit 110, enclosing the battery compartment 111, the control unit 112, and the motor 115. The switch 113 supported by the switch base 114 is affixed to the side of the base unit 110 and electrically connected to the control unit 112. The control unit 112 includes a microprocessor (not shown) that is preferably a single circuit card which is capable of controlling the various functions of the automatic living food dispenser. The control unit 112 also includes a timer (not shown) that controls time-sensitive functions and a memory (not shown) that stores various instructions input. The drive shaft 116 extends upwardly through a hole in the base lid 120 and a hole in the main compartment 140. The drive wheel 130 is mechanically linked to the drive shaft 116. The main compartment 140 is mounted on top of the base lid 120 and fixed by a turn and lock mechanism. The rotatable carousel 150 is placed inside the main compartment 140, such that a drive gear 158 facing the exterior on the bottom of the rotatable carousel as shown in FIG. 11 is mounted concentrically on the drive wheel 130. The top lid is fitted over the main compartment 140 housing the rotatable carousel 150 by a press and click mechanism. The loading cover 161 is mechanically fastened to the center of the top lid 150 enclosing a loading hole 164 as shown in FIGS. 12 and 13.

In operation, living food is placed inside the main compartment 150 housing the rotatable carousel 150 by lifting the top lid 160 off from the main compartment 140 or by removing the loading cover 161 to expose the loading hole 164 as shown in FIGS. 12 and 13. In the following description, a live food source for a caged pet is called a “living food,” but may be any other “feeder,” “feeder animal,” “feeder insect,” “prey animal,” “prey insect,” “live food,” or the like. Similarly, it should be understood that the device “automatic living food dispenser” does not limit the application of the invention to a specific living food. Living food is compartmentalized by two or more cavities 151 as shown in FIG. 10. Living food gravitationally travels down from the main compartment 150 to external environment when a food release hole 144 aligns with one of the cavities 151 where living food is held. As an example, the living food may be crickets.

In operation, a user sets the timer according to a desired feeding schedule using the switch 113. The desired feeding schedule is stored in the memory in the control unit 112. At a predetermined time, a release signal, an electrical communication signal representative of execution to release living food, from the timer is received at the microprocessor in the control unit 112. The microprocessor transmits the digital representation of the release signal to the motor 115. When the digital representation of the release signal is received by the motor 115, the motor 115 rotates the drive shaft 116 according to a designated speed. The drive shaft 116 is mechanically engaged with the drive wheel 130, which is mechanically engaged with the drive gear 158 that is affixed to the bottom of the rotatable carousel 150. In this way, the rotatable carousel 150 is rotated by the motor 115 and the drive shaft 116.

In one embodiment, programming of the automatic living food dispenser system 100 may operate through hardware, firmware, software, or some combination thereof.

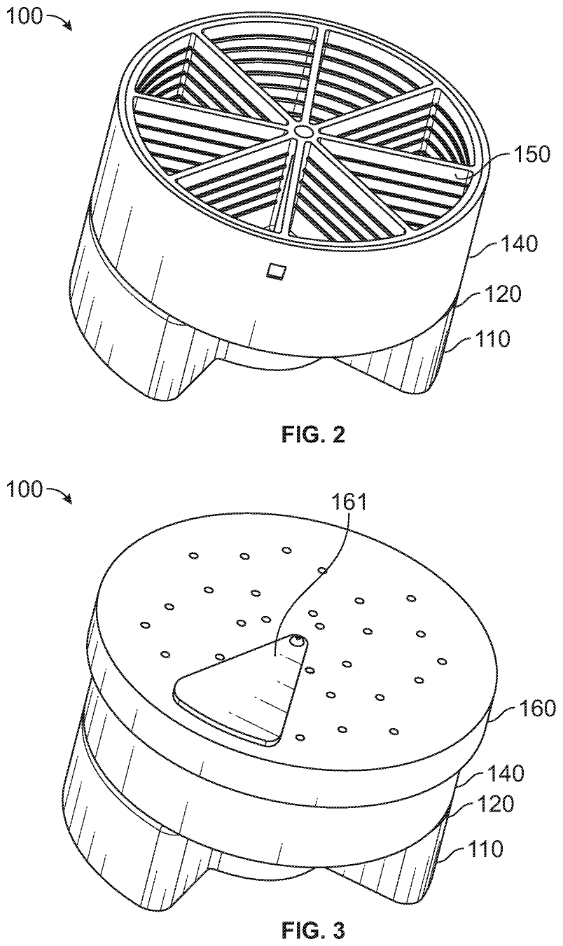

FIG. 2 illustrates an assembled view of an automatic living food dispenser system 100 without a top lid 160. Here, the automatic living food dispenser system 100 includes a base unit 110, a base lid 120, a main compartment 140, and a rotatable carousel 150. The base unit 110 is enclosed by the base lid 120. The main compartment 140 is mounted on top of the base lid 120 and held in place by a turn and lock mechanism. The rotatable carousel 150 is placed inside the main compartment 140 concentrically.

In operation, the motor 115 rotates the rotatable carousel 150. When one of the cavities 151 of the rotatable carousel 150 holding living food aligns with the food release hole 144, living food in the cavity 151 may gravitationally drop to external environment and thus may become available to a pet to consume. The base unit 110 and the base lid 120 is cylindrically shaped with an inverted wedge mouth 118 that flares in a direction toward the circumference. The inverted wedge mouth 118 is greater in angular degree than one of the cavities 151 for the living food to be dropped from the cavity 151 freely.

FIG. 3 illustrates an assembled view of an automatic living food dispenser system 100 with a top lid 160. Here, the automatic living food dispenser system 100 shows a base unit, a base lid 120, a main compartment 140, a top lid 160, and a loading cover 161. The base unit 110 is enclosed by the base lid 120. The main compartment 140 is seated on top of the base lid 120. The top lid 160 is fitted over the main compartment 140. The loading cover 161 overlie the loading hole 164 such that the loading cover 161 completely covers the opening to the main compartment 140.

In operation, living food is dropped into each cavity 151 by removing the loading cover 161 and exposing a loading hole 164 as shown in FIG. 12. Alternatively, living food may be loaded into all cavities 151 at once by removing the top lid 160 completely and exposing the main compartment 140 housing the rotatable carousel 150 as shown in FIG. 2.

Alternatively, the loading cover 161 may be made of a rubber that is biased in a closed position, but flexible enough to allow a user to open and insert or check the living food without having to completely move the top lid 160. In addition, one or more of the cavities 151 may be made of or have a darken surface. The darken surface has been shown to increase live food survivability by keeping the live food in a sense that it is night, decreasing their activity and metabolism.

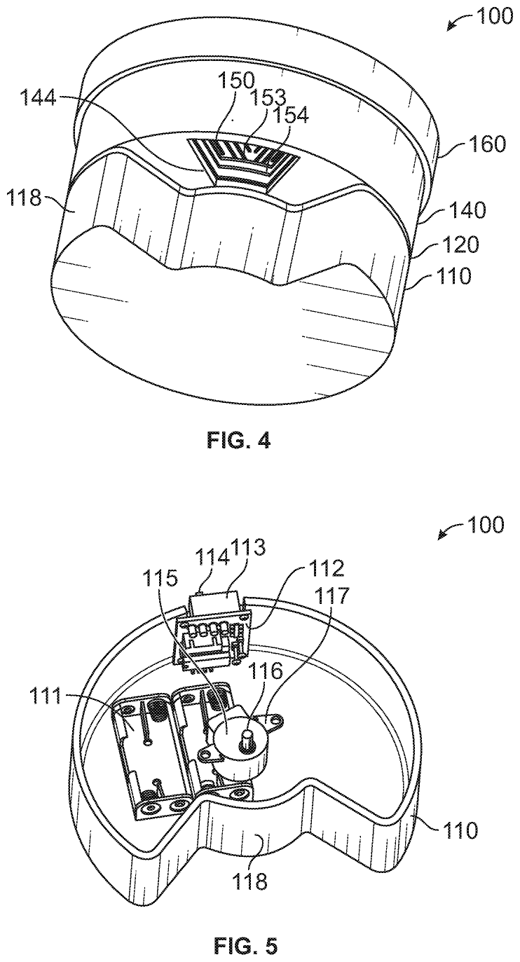

FIG. 4 illustrates a bottom view of an automatic living food dispenser system 100. Here, the automatic living food dispenser system 100 shows a base unit 110, a base lid 120, a main compartment 140, and a top lid 160. From the bottom view, the main compartment 140 includes a food release hole 144, which exposes a rotatable carousel 150 housed in the main compartment 140. The rotatable carousel 150 includes a textured inner surface 153 and a nutrient ledge 154. The base lid 120 is fitted over the base unit 110. The main compartment 140 is mounted on the base lid 120 and secured in place by a turn and lock mechanism. The base unit 110 and the base lid 120 is shaped cylindrically with an inverted wedge mouth 118 that flares in a direction toward the outer circle. The inverted wedge mouth 118 is physically larger than one of the cavities 151 in at least one dimension, exposing the food release hole 144 of the main compartment 140.

In operation, living food compartmentalized by the rotatable carousel 150 is housed in the main compartment 140. The textured inner surface 153 maximizes surface area for habitation of the living food awaiting to be pushed out by a rotational force by providing more than one textured side for the living food to position itself without slipping or falling. The nutrient ledge 154 circularly outlines a nutrient compartment 155, as shown in FIG. 10, and secures the nutrient for living food from falling out of the main compartment 140. The motor 115 rotates the rotatable carousel 150 when the motor 115 receives the release signal from the microprocessor in the control unit 112. As the rotatable carousel 150 rotates, living food inside each cavity 151 move along with the rotatable carousel 150 while the main compartment 140 remains fixed. When one of the cavities 151 holding living food aligns with the food release hole 144, living food is gravitationally dropped to external environment.

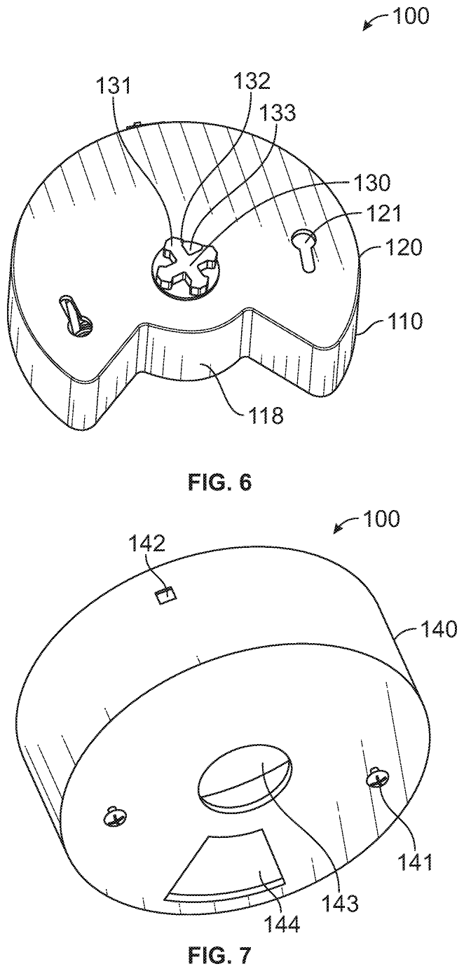

FIG. 5 illustrates a detailed inner view of the base unit. The base unit 110 includes a battery compartment 111, a control unit 112, a switch base 113, a switch 114, a motor 115, a drive shaft 116, and a motor mounting plate 117. The battery compartment holds batteries that power the automatic living food dispenser 100. The control unit 112 is electrically connected to the battery compartment 111, the motor 115, and the switch 114. The motor 115 is operatively connected to the drive shaft 116, which is affixed to the drive wheel 130, as shown in FIG. 6. The motor 115 is also affixed onto posterior of the base lid 120 by one or more motor mounting plates 117. The switch 113 supported by the switch base 114 is affixed to the side of the base unit 110 protruding outwards for a user to operate.

In operation, the control unit 112 is programmed, in part, to control power to the motor 115 that drives the drive shaft 116 affixed to the drive wheel 130. The drive wheel 130, fitted together with the drive gear 158 of the rotatable carousel 150, pivots, turning the rotatable carousel 150 housed in the main compartment 140. The control unit 112 may further control and monitor one or more position sensors (not shown) used to determine a position of the rotatable carousel 150 relative to the food release hole 144. The sensors may be optical sensors or photo-couplers.

Here, the dispensing mechanism is actuated according to a timer (not shown) set by the switch 113. In one embodiment, the switch 113 has four modes: an OFF mode, a 12 hour mode, a 24 hour mode, and a LOADING mode. The timer in the control unit 112 is programmed to read a position of the switch 113 and provide a release signal indicative of a food release time at the food release time when the switch 114 is set to the 12 hour or the 24 hour mode. The desired feeding schedule indicated by 12 hour or 24 hour mode is stored in the memory in the control unit 112. For example, if the switch 113 is set to the 12 hour mode, the desired feeding schedule of 12 hour frequency is stored in the memory in the control unit 112. The timer in the control unit 112 is further programmed to provide a release signal indicative of food release time in 12 hour intervals to the microprocessor in the control unit 112. Upon receiving the release signal, the microprocessor in control unit 112 transmits the release signal to the motor 115, which then runs and rotates the drive shaft 116 that is mechanically attached to the motor 115 in a release direction until a predetermined angular rotation has been reached. The predetermined angular rotation is equivalent to angular distance of one cavity 151, and is stored in the memory in the control unit 112. Thus, the motor 115 runs until next one of cavities 151 of the rotatable carousel 150 is aligned with the food release hole 144, as in FIG. 4, releasing the stored living food for a pet to consume.

The control unit 112 is further programmed to read a position of the switch 113 and provide a loading signal indicative of a loading mode when the switch 113 is set to the loading mode. A loading angular rotation is continuously stored and updated in the memory in the control unit 112 when the switch 113 is set to the loading mode until the switch 113 is no longer set to the loading mode. Upon receiving the loading signal, the control unit 112 triggers the motor 115 to run and rotate the drive shaft 116 that is mechanically attached to the motor 115 in a loading direction, which is a direction opposite to release direction. For example, if the release direction is programmed to be clockwise, then the loading direction is counter-clockwise. The motor 115 runs in a direction opposite to release direction until the control unit 112 reads that the switch 113 is no longer set to the loading mode. When the switch 113 is no longer set to the loading mode, an offset angular distance is calculated from the predetermined angular rotation and the loading angular rotation stored in the memory in the control unit 112. The motor 115 runs until the offset angular distance is zero and, consequently, the next one of cavities 151 of the rotatable carousel 150 is aligned with the food release hole 144.

The control unit 112 may include other features such as a low battery light to direct the user to change the batteries.

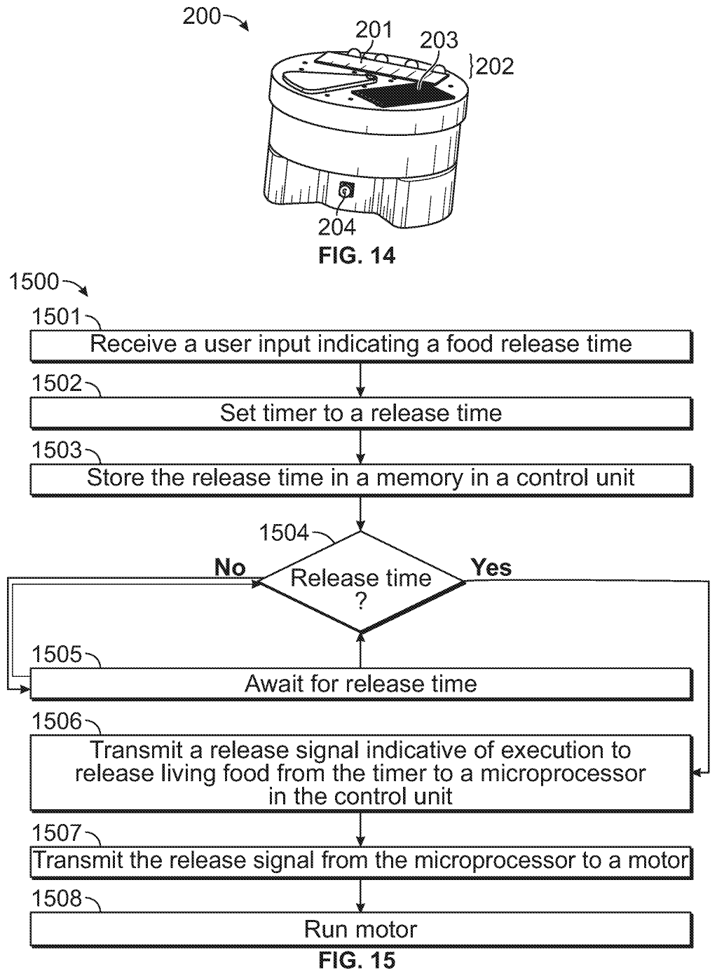

Alternatively, the dispensing mechanism may be actuated according to a time set by the user or the manufacturer using a control panel, as further discussed in FIG. 14. In another embodiment, a rechargeable power source can be substituted for the batteries. As further discussed in FIG. 14, a solar panel may alternatively be attached to the top lid 160 and electrically connected to the rechargeable power source for supplying a charging current to the rechargeable power source.

It is preferable that the motor 115 is a step motor. The control unit 112 may be programmed to control the motor without a position sensor. For example, the control unit 112 may be programmed to initiate the motor 115 until a predetermined angular distance has been reached. Here, the angular distance is 45 degrees for an automatic living food dispenser with 8 cavities.

FIG. 6 illustrates a detailed view of the base unit with the base lid and the drive wheel. The base lid 120 includes a plurality of mounting holes 121. The drive wheel has a plurality of arms 131, a plurality of flanges 132, a plurality of mouths 133. The base lid 120 is fitted over the base unit 110, and the drive wheel 130 is mechanically attached to the drive shaft 116 that extends upwards above the base lid 120, such that the drive wheel 130 and the drive shaft 116 moves together in a single motion. The mounting hole 121 is shaped such that a mounting lock 141 is fitted downward through the base lid 120 when properly positioned with the mounting hole, as shown in FIG. 7. The drive wheel 130 is a generally circular disc member having a plurality of outwardly extended radially-spaced, triangular-shaped arms 131. Each arm 131 has a pair of oppositely extended flanges 132 that are spaced from each other to form a mouth 133.

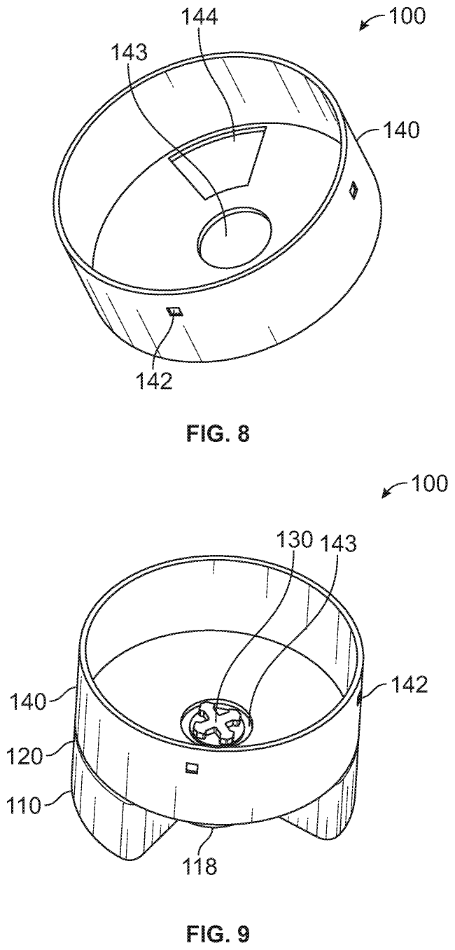

FIG. 7 illustrates a detailed bottom view of the main compartment. FIG. 8 illustrates a detailed top view of the main compartment. The main compartment 140 includes a plurality of mounting locks 141, a plurality of click holes 142, a drive wheel hole 143, and a food release hole 144. The main compartment 140 is cylindrically shaped with an open top. The two mounting locks 141 on the underside of the exterior mates with the two mounting holes 121 on the base lid 120. When the mounting lock 141 is fitted downward through the base lid 120 into the mounting hole 121, the main compartment 140 can be rotated to lock the mounting members in a turn and lock mechanism. The main compartment 140 and the base lid 120 can be subsequently loosened by rotating the main compartment 140 in an opposite direction and lifting the main compartment 140 upward. Three circumferentially spaced rectangular click holes 142 on a cylindrical wall of the main compartment 140 engages with the top lid 160. When fitted, a click lock 165 on the underside of the top lid 160 mates with the click holes 142 of the main compartment 140, locking in the assembly. The drive wheel hole 143 is a circular orifice at the center of the main compartment 140, through which the drive wheel 130 protrudes upward. The food release hole 144 is a wedge-shaped orifice concentrically positioned at a greater radius than the drive wheel hole 143 that has the same an angular degree as one of the cavities 151 of the rotatable carousel 150. The food release hole 144 is further positioned directly on top of the inverted wedge mouth 118 of the base unit 110.

FIG. 9 illustrates a detailed assembled view of the main compartment and the base unit. The main compartment 140 includes a plurality of click holes 142 and a drive wheel hole 143. The base lid 120 is fitted over the base unit 110. The drive wheel 130 mounted on top of the center of the base lid 120 projects through the drive wheel hole 143. The drive wheel 130 does not touch the inner concentric circle of the drive wheel hole 143. In operation, the motor 115 triggers the drive wheel 130 to rotate along with the drive shaft 116. The base unit 110 and the main compartment 140 remains locked and held in place while the drive wheel 130 is rotating.

FIG. 10 illustrates a detailed view of the rotatable carousel. The rotatable carousel 150 includes a cavity 151, a lid female notch 152, a textured inner surface 153, a nutrient ledge 154, a nutrient compartment 155, a sleeve 156, a partition 157 and an outer wall 158. The rotatable carousel is cylindrical in form and has approximately the same outer diameter as an inner diameter of the main compartment 140. Extending centrally throughout the container on its axis is a sleeve 156. Partitions 157 extend radially between and are rigidly joined to the sleeve 156 and the outer cylindrical wall 158 of the rotatable carousel 150 to form its separate cavities 151. The rotatable carousel 150 is open at both its top and bottom ends. The rotatable carousel 150 seats coaxially on the main compartment 140 which thus closes the open bottom ends of cavities 151 of the rotatable carousel 150. The nutrient compartment 155 is a circular nutrient plate 156 fixed to the bottom of the rotatable carousel 150 in a generally horizontal position with the nutrient ledge 154 projecting the outline of the circular plate slightly upwards. The nutrient compartment 155 is smaller in diameter than the rotatable carousel 150. The upper end of the rotatable carousel 150 is closed by a lid 160, which has a lid male notch 166 that registers with the lid female notch 152 of the rotatable carousel 150. The lid female notch 152 and the lid male notch 166 are positioned in the center of the automatic living food dispenser 100.

In operation, the rotatable carousel 150 is movable relative to the main compartment 140 that is fixed to the base lid 120 fitted over the base unit 110 in a direction to effect movement of the cavities 151 in a succession where the bottom opening of each cavities 151 registers with the food release hole 144 of the main compartment 140. The living food stored in the main compartment 140 and compartmentalized by the rotatable carousel 150 empties from the main compartment 140 through the food release hole 144 into the external environment. A user places a nutrient (not shown) for living food in each nutrient compartment 115 by opening the top lid 160 to access the main compartment 140. For example, a nutrient may be nutrient cube made of food, vitamins, and water formulated to be easily digested by crickets. The number of cubes placed inside the nutrient compartment will vary depending on how many cavities 151 are filled with crickets. The nutrient compartment 155 holds nutrient for living food, and the nutrient ledge 154 ensures that the nutrient stays inside the main compartment 140 when the corresponding cavity 151 registers with the food release hole 144 of the main compartment 140. The textured inner surface allows living food to utilize larger surface area while being stored in the main compartment 140, having more than one textured wall for the living food to position itself without slipping or falling

FIG. 11A illustrates a detailed bottom view of the rotatable carousel. The rotatable carousel 150 includes a drive wheel axle 157 and a drive gear 158. The drive wheel axle 157 and the drive gear 158 are concentrically located relative to the rotatable carousel 150. As noted, the motor 115 is mounted on the underside of the base lid 120 and rotates the drive shaft 116, which in turn rotates the drive wheel 130. The drive wheel 130 is aligned with the drive wheel axle 157, which is the central axis of the rotatable carousel 150, and registers with the drive gear 158 of the rotatable carousel 150.

FIG. 11B illustrates another rotatable carousel 150′ configured to be easily removed and swapped out to provide another type of feeding compartment for holding different insets.

FIG. 12 illustrates a detailed bottom view of the top lid. The top lid 160 includes an air hole 163, a loading hole 164, a click lock 165, a lid male notch 166, and a peripheral flange 167. An upper end of the rotatable carousel 150 is closed by the top lid 160 having a peripheral flange 167 which fits snugly but removably over the upper end of the rotatable carousel 150 and an outer wall of the main compartment 140. The top lid 160 is secured by the click lock 165 by a press and click mechanism. The top lid 160 is further secured by the lid male notch 166 engaging with the lid female notch 152 of the rotatable carousel 150. The loading hole 164 is wedge-shaped orifice that flares in a direction toward the circumference. The loading hole 164 has the same angular degree as one of the cavities 151 of the rotatable carousel 150. Air holes 163 are pinholes spatially scattered on the top lid 160, providing circulation through the main compartment 140.

FIG. 13 illustrates a detailed top view of the top lid. The top lid 160 includes a loading cover 161, a top screw 162, and an air hole 163. As noted, the loading cover 161 is mechanically fastened by the top screw 162 to the center of the top lid 150 snugly enclosing the loading hole 164. The loading cover 161 is also wedge-shaped that flares in a direction towards the circumference.

FIG. 14 illustrates an automatic living food dispenser 200 with optional features. In one embodiment, the automatic living food dispenser 200 includes a user interface 201, a control panel 202, a solar panel cells 203, and a video recording system 204. The control panel 202 allows a user to manually program the automatic living food dispenser according to a schedule for a pet. The manual programming may be established through a selection process of some finite number of dispensing characteristics or parameters using radio push buttons or by rotating one or more selector switches and pressing buttons, or by navigating the user interface 201, which displays a programmable LCD clock or lists selections on a LCD display or touch screen, resulting in changes to the default settings associated with dispensing characteristics or parameters. In one embodiment, the programmable LCD clock is configured to accept a food release time input indicating a food release time, and a timer is configured to provide a release signal at said food release time accepted by said programmable LCD clock. The solar panel cells 203 charges a rechargeable battery to power the automatic living food dispenser through the use of photovoltaic cells. The video recording system 204 records video clips when living food is released from the automatic living food dispenser so that the user can access the video and watch the pet during feeding time. The control unit includes a transceiver that is in wireless electrical communication with an external device via telecommunications network or via wireless signals according to Wi-Fi or Bluetooth protocol.

FIG. 15 is a flowchart 1500 illustrating an embodiment of a process for initiating the motor 115 executed by the automatic living food dispenser 100. At step 1501, the automatic living food dispenser 100 receives a user input indicating a food release time. At step 1502, timer is set to a release time. At 1503, the release time is stored in a memory in a control unit. At step 1504, if timer is equal to the release time, the process proceeds to step 1506. If timer does not equal to the release time at step 1504, the process proceeds to step 1505. At step 1505, the timer awaits for release time and circles back to step 1504. At step 1506, the timer transmits a release signal indicative of execution to release living food to a microprocessor in the control unit. At step 1507, the microprocessor transmits the release signal to a motor. At step 1508, the motor runs.

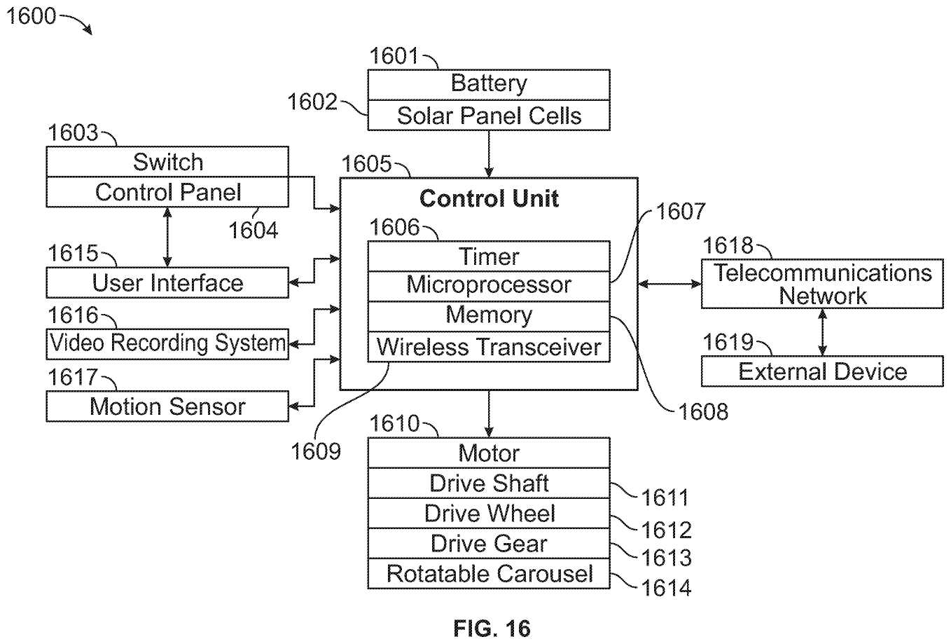

FIG. 16 illustrates an automatic living food dispenser 1600 according to an embodiment of the invention. The automatic living food dispenser 1600 includes a battery 1601, a solar panel cells 1602, a switch 1603, a control panel 1604, a control unit 1605, a motor, 1610, a drive shaft 1611, a drive wheel 1612, a drive gear 1613, a rotatable carousel 1614, a user interface 1615, a video recording system 1616, a motion sensor 1617, a telecommunications network 1618, and an external device 1619. The control unit 1615 includes a timer 1606, a microprocessor 1607, a memory 1608, and a wireless transceiver 1609.

In the automatic living food dispenser 1600, the switch 1603 and the control panel 1604 are in electrical connection with the control unit 1605. The switch 1603 and the control panel 1604 are also in electrical connection with the user interface 1615, which is in electrical connection with the control unit 1605. The battery 1601 and the solar panel cells 1602 are in electrical connection with the control unit 1605. The video recording system 1616 is in electrical connection with the control unit 1605. The motion sensor 1617 is in electrical connection with the control unit 1605. The motor 1610, the drive shaft 1611, the drive wheel 1612, the drive gear 1613, and the rotatable carousel 1614 are in electrical connection with the control unit 1605. The telecommunications network 1618 is in wireless connection with the control unit 1605. The external device 1619 is in wireless connection with the telecommunications network 1618.

In operation, the battery 1601 and the solar panel cells 1602 provide power to the control unit 1605. A user sets a desired feeding time using the switch 1603 and the control panel 1604. The control panel 1604 allows the user to manually program the automatic living food dispenser according to the feeding schedule for the pet. The user interface 1615 may display a programmable LCD clock or list selections on an LCD display or touch screen. The input data indicative of the feeding schedule from the switch 1603, the control panel 1604, and the user interface 1615 is transmitted to the control unit 1605 and stored in the memory 1608. The input data indicative of the feeding schedule actuates the timer 1606. According to the feeding schedule, the timer 1606 sends a release signal indicative of a food release time at the food release time to the microprocessor 1607. The microprocessor 1607 transmits the release signal to the motor 1610, which then runs and rotates the drive shaft 1611. The drive shaft is mechanically attached to the drive wheel 1612, which is mechanically attached to the drive gear 1613 on the rotatable carousel 1614. Consequently, the motor 1610 turns the rotatable carousel 1614 concentrically. The wireless transceiver 1609 of the control unit 1605 transmits an output data indicative of a status of the automatic living food dispenser and the like to the telecommunications network 1618 through a wireless connection. The wireless transceiver 1609 also receives an input data, originating from the external device 1619, indicative of a desired execution for the automatic living food dispenser and the like from the telecommunications network 1618 through a wireless connection. The motion sensor 1617 transmits a motion data indicative of a position of the rotatable carousel 1614 to the control unit 1605. The video recording system 1616 transmits an input data representing a video file to the control unit 1605. The control unit 1605 stores the data representing the video file in the memory 1608.

The automatic living food dispenser 100 may be made of molded plastic or other suitable material. Using a translucent plastic allows living food placed inside the cavities 151 to be viewed from the outside.

Conventional insect feeding systems are typically manually operated. Conventional pet feeding systems are inappropriate for living food, such as crickets, that need its own air circulation and nutrients within a storage apparatus. These systems are inflexible to the needs of caged pet owners as they have a need to feed their pets, such as reptiles, on an automated basis. The need typically arises when the owner is absent and is unable to feed a pet at appropriate times.

As explained by Cunningham in U.S. Pat. No. 5,630,374, “Feeding crickets to one's pet reptile is an often messy and wasteful task. The crickets are generally packaged and brought from the store in plastic bags or cups. The pet owner will keep them in a lidded container, opening the container periodically to feed his pet. Each time, he must attempt to pour the correct number of crickets into the reptile's aquarium or other habitat as “excess” crickets are otherwise wasted due to their inability to seek food. Crickets often jump out of the container and escape into the house despite the owner's most careful efforts in doling out a meal. This forces customers to restrict their purchases to a two or three-day supply requiring frequent trips to the pet store.”

The present embodiment provides a device that minimizes the need for the pouring of crickets that provides an opportunity for their entropic escape because a plurality of crickets enough to nourish a pet for a longer duration can be loaded into the automatic living food dispenser at once using a loading hole or a top lid. The present embodiment also lessens the need to touch and handle the crickets once they are loaded into the device because the crickets are provided with air through an air hole and nutrients in a nutrient compartment to live inside the device and the device is set to automatically dispense crickets at a predetermined time and interval. In addition, the present embodiment provides the ability to control with consistency the number of crickets fed to the cricket-eating pet because a rotational carousel of the automatic living food dispenser compartmentalizes the crickets so that the dispensed living food is rationed and released at a predetermined feeding time at an interval.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

We claim:

1. An automatic living food dispenser including:
a rotatable carousel having a top and a bottom that are open and a plurality of cavities to compartmentalize two or more living food;
a main compartment housing said rotatable carousel, said main compartment comprising a food release hole;
a base unit supporting said main compartment, said base unit having an inverted wedge mouth that is physically larger than said food release hole in at least one dimension; and
a top lid with a plurality of air holes.

2. The automatic living food dispenser of claim 1, further comprising:
a rotary mechanism for rotating said rotatable carousel relative to said base unit; and
a control unit including a timer, said timer configured to send a release signal to a microprocessor indicating a food release time,
wherein said microprocessor is configured to receive said release signal and activate said rotary mechanism to rotate said rotatable carousel and align one of said cavities with said food release hole.

3. The automatic living food dispenser of claim 2, wherein each of said cavities holds a nutrient compartment and a textured inner surface.

4. The automatic living food dispenser of claim 2, wherein said microprocessor is configured to standby until a next release signal from said timer.

5. The automatic living food dispenser of claim 3, wherein said timer is configured to provide said release signal at fixed, predetermined, or set time intervals.

6. The automatic living food dispenser of claim 2, wherein said top lid comprises a loading hole and a loading cover that overlie said loading hole.

7. The automatic living food dispenser of claim 2, wherein said base unit comprises a base lid, wherein said main compartment is attached to said base lid by a turn and lock mechanism.

8. The automatic living food dispenser of claim 2, wherein said top lid overlie said main compartment housing said rotatable carousel by a press and click mechanism.

9. The automatic living food dispenser of claim 2, further comprising a control panel affixed to said top lid, and wherein the control panel includes a user interface with a programmable LCD clock configured to accept a food release time input indicating a food release time, and wherein said timer is configured to provide a release signal at said food release time accepted by said programmable LCD clock.

10. The automatic living food dispenser of claim 2, further comprising a communication unit for communicating with an external device having a transceiver via wireless communication.

11. The automatic living food dispenser of claim 2, further comprising a video recording system for recording a video clip.

12. The automatic living food dispenser of claim 2, further comprising a position sensor configured to sense position of said rotatable carousel, said position sensor further configured to send a stop rotating signal indicating said next cavity is aligned with said food release hole.

13. The automatic living food dispenser of claim 12, wherein said rotary mechanism rotates said rotatable carousel in a release direction.

14. The automatic living food dispenser of claim 13, wherein said microprocessor is further configured to receive a loading signal indicating a loading mode, said microprocessor further configured to activate said rotary mechanism to rotate said rotatable carousel in a loading direction until next one of said cavities is aligned with said food release hole, wherein said loading direction is a direction opposite to said release direction.

15. A method of dispensing living food, comprising:
placing one or more living food into at least one cavity in a rotatable carousel, wherein said cavity includes a nutrient compartment supporting a nutrient for said living food;
placing said nutrient for said living food in said nutrient compartment;
receiving a release signal to activate a rotary mechanism; and
activating said rotary mechanism to rotate said rotatable carousel and align one of said cavities with a food release hole.

16. An automatic living food dispenser including:
a rotatable carousel having a top and a bottom that are open and a plurality of cavities to compartmentalize two or more living food, and wherein each of said cavities holds a nutrient compartment and a textured inner surface;
a main compartment housing said rotatable carousel, said main compartment comprising a food release hole;
a base unit supporting said main compartment, said base unit having an inverted wedge mouth that is physically larger than said food release hole in at least one dimension; and
a top lid with a plurality of air holes.

17. The automatic living food dispenser of claim 16, further comprising:
a rotary mechanism for rotating said rotatable carousel relative to said base unit; and
a control unit including a timer, said timer configured to send a release signal to a microprocessor indicating a food release time,
wherein said microprocessor is configured to receive said release signal and activate said rotary mechanism to rotate said rotatable carousel and align one of said cavities with said food release hole.

18. The automatic living food dispenser of claim 17, wherein said timer is configured to provide said release signal at fixed, predetermined, or set time intervals.

19. The automatic living food dispenser of claim 17, wherein:
said top lid comprises a loading hole and a loading cover that overlie said loading hole; and
said base unit comprises a base lid, wherein said main compartment is attached to said base lid by a turn and lock mechanism.

20. The automatic living food dispenser of claim 17, further comprising a control panel affixed to said top lid, and wherein the control panel includes a user interface with a programmable LCD clock configured to accept a food release time input indicating a food release time, and wherein said timer is configured to provide a release signal at said food release time accepted by said programmable LCD clock.
